(19) United States
(12) Patent Application Publication
(10) Pub. No.: US 2021/0068212 A1
(43) Pub. Date: Mar. 4, 2021

(54) HOUSEHOLD APPLIANCE HAVING A TEMPERATURE DETECTOR

(71) Applicant: BSH Hausgeräte GmbH, Munich (DE)

(72) Inventors: Christian Böttcher, Traunstein (DE); Andreas Kaiser, Halfing (DE); Markus Kuchler, Gstadt am Chiemsee (DE); Matthias Vogt, Obersulm (DE)

(21) Appl. No.: 16/643,853

(22) PCT Filed: Aug. 29, 2018
(86) PCT No.: PCT/EP2018/073218

§ 371 Date: Mar. 3, 2020

(30) Foreign Application Priority Data
Sep. 11, 2017 (DE) 10 2017 215 966.9

(51) Int. Cl. H05B 6/64; G01J 5/10; G01J 5/00

(52) U.S. Cl. CPC H05B 6/6455; G01J 5/0096; G01J 5/10

(57) ABSTRACT

A household appliance includes a circuit component, a temperature detector embodied as an IR detector and configured to sense a temperature of the circuit component, and a control facility coupled to the temperature detector and configured to actuate the circuit component and to actuate the household appliance on the basis of temperature measurement data measured by the temperature detector.

The invention relates to a household appliance, which has at least one circuit component, a control facility for actuating the at least one circuit component and a temperature detector, which is coupled to the control facility. The invention also relates to a method for operating such a household appliance. The invention is in particular advantageously able to be applied to microwave cooking appliances, such as self-contained microwave cooking appliances or ovens, e.g. baking ovens, with microwave functionality.

Previously known solid-state amplifiers in microwave cooking appliances use a feedthrough network which is connected downstream of at least one transistor. The solid-state amplifier has inter alia a circulator for protecting the transistor from microwave power reflected back from a cooking compartment, a unit for capturing or measuring the reflected microwave power and also an end load for dissipating the reflected microwave power.

For measuring the temperature of cooking utensils, DE 298 039 05 U1 discloses a hob with a hob frame, on which a sensor assembly is retained, which has a receiving part fastened below the hob frame and a tube-shaped sensor part guided in a vertically displaceable manner therein with a viewing window, through which, when the sensor part has been pulled up and out through a frame opening, thermal radiation falls on an infrared sensor arranged in the sensor part, whereby a contactless measurement of the wall temperature of a heat-emitting cooking appliance placed on the hob is possible.

DE 10 305 368 A1 discloses an electric motor, which has a plurality of components such as stator, rotor, windings and bearings, the operation-dependent temperatures of which are monitored, wherein said components have temperature sensors for ascertaining their absolute temperatures. The temperature sensors are thermal radiation sensors, which enable a contactless capturing and/or measuring of the emitted heat.

The object of the present invention is to overcome the disadvantages of the prior art, at least in part, and in particular to provide an option for a particularly safe and reliable operation of a microwave household appliance, in particular of a microwave cooking appliance.

This object is achieved in accordance with the features of the independent claims. Advantageous embodiments are the subject matter of the dependent claims, the description and the drawings.

The object is achieved by a household appliance, having at least one circuit component, a control facility for actuating the at least one circuit component and at least one temperature detector for sensing a temperature of at least one circuit component, wherein the control facility is coupled to the temperature detector and is configured to actuate the household appliance on the basis of temperature measurement data measured by the temperature detector, and wherein the at least one temperature detector is an IR detector.

Said household appliance has the advantage that a circuit component is able to be monitored for an abnormal or temperature-critical operation by way of the temperature measurement. A temperature-critical operation may, for example, comprise operation after exceeding a component limit temperature or an excessively rapid temperature rise.

The use of an IR detector specifically results in the advantage that a particularly high detection speed and precision of the temperature measurement is achieved, as thermal inertia practically plays no role. This in turn enables a particularly rapid and/or precise controllability of the monitored circuit component for adjusting its temperature.

A further advantage of the use of an IR detector is that it practically does not influence the circuit component, as it typically has no metallic regions which need to be brought close to the circuit components. By contrast, contacting thermocouples such as platinum measuring resistors or the like may interfere with said circuit component when they touch the circuit component or are located in the vicinity thereof. In this case, it is also possible for the connection lines of contacting thermocouples to disadvantageously decouple a signal.

Contacting thermocouples also have a higher thermal inertia than an IR detector, in particular when the thermocouple has to be arranged at a distance from the circuit component to be sensed. Particularly in the case where the thermocouple has to be arranged at a distance from the circuit component to be sensed, in order to not interfere with it, it is not possible to measure the temperature of the circuit component in a sufficiently precise and instantaneous manner using thermocouples, and it is therefore not possible to respond to a thermal overload of the component in a sufficiently rapid manner.

The household appliance may be a household cooking appliance.

The at least one circuit component which can be sensed or detected is therefore situated in a field of view of the IR detector.

The IR detector may sense precisely one circuit component or a plurality of circuit components. To this end, precisely one circuit component or a plurality of circuit components accordingly may be located in the field of view or detector region of the IR detector. The household appliance may have one or more IR detectors.

In one development, at least one IR detector is an IR detector which does not spatially resolve. Such an IR detector is particularly cost-effective and robust and additionally can be evaluated particularly simply.

It is also a development that the IR detector is a spatially resolving IR detector. This results in the advantage that additional information can be obtained and moreover that it is possible to distinguish between a plurality of heat sources located in the field of view of the IR detector, e.g. comprising a plurality of circuit components.

The IR detector may have one or more IR sensors. The IR detector may have one or more thermopiles or chains of thermocouples as IR sensors. The IR detector may also, however, be an IR-sensitive semiconductor chip, e.g. a CCD sensor. In addition to the at least one IR sensor, the IR detector may have optics connected upstream of the at least one IR sensor. The optics may for example have at least one lens, at least one shutter, etc.

In the event that a plurality of circuit components are sensed by one or more IR detectors, it is possible to exactly differentiate between the respective component temperatures by way of assigned sensors. For example, as opposed to a temperature measurement using a thermocouple, there are no measurement errors due to overlaying the temperatures of the various circuit components. In particular, it is thus also possible to identify asymmetrical thermal loads on the circuit components and in particular also the smallest errors in a respective component as a result.

In the event that an IR detector which detects on the basis of images or pixels is configured and arranged to sense the temperature of a plurality of circuit components or a plurality of circuit components are located in the field of view or detector region of the IR detector, it is an advantageous development that local temperature regions are able to be assigned to respective circuit components in an image recorded by the IR detector.

A circuit component may be understood to mean a component of a circuit or a circuit network. The circuit component may be an electrical or electronic component. The circuit component may be an ohmic resistor, a capacitor, a coil or the like, for example. The circuit component may also be a semiconductor component. The circuit component may be an integrated circuit or have an integrated circuit.

In one development, the control facility is configured to actuate at least one temperature-sensable circuit component on the basis of the temperature measurement data measured by the temperature detector.

The control facility being configured to actuate at least one sensable circuit component on the basis of the temperature measurement data measured by the temperature detector may, in one embodiment, comprise at least one action being triggered or being able to be triggered by the household appliance on the basis of an occurrence of an event which can be determined by the temperature measurement data. The occurrence of the event may comprise an operation in a critical temperature range or an expected entry into the critical temperature range. The action may be an outputting of a warning to a user and/or a triggering of at least one countermeasure for lowering the temperature.

The configuring of the control facility may comprise the programming thereof.

In one embodiment, at least one circuit component which can be sensed by the IR detector is a high-frequency (HF) circuit component. In this context, the IR detector is able to be used particularly advantageously, as HF components are particularly strongly influenced by the presence of metallic objects in their vicinity. In this embodiment, contacting thermocouples such as platinum measuring resistors or the like have to be arranged at a distance from the sensing HF circuit component, in order to not interfere with it, e.g. on a cooling element of the circuit component. Consequently, due to the thermal inertia or the thermal resistance of the overall system, it is not possible to measure the temperature of a HF circuit component in a precise and instantaneous manner using thermocouples, and it is therefore also not possible to respond to a thermal overload of the HF circuit component in a sufficiently rapid manner.

In one development, at least one HF component is an HF transistor. In another development, at least one circuit component is a part or a component of an amplifier circuit.

In an additional development, at least one circuit component is a part or a component of a feedthrough network. The feedthrough network may be connected downstream of the HF transistor. The feedthrough network may represent a part of the amplifier circuit together with the HF transistor, or correspond to the amplifier circuit. The feedthrough network may inter alia have a circulator for protecting the HF transistor, a unit for capturing the reflected microwave power (e.g. a directional coupler) and/or an end load for dissipating microwave power reflected back from a cooking compartment.

In another embodiment, the household appliance is a microwave appliance and the at least one HF component is a microwave component. To generate the microwaves, the microwave appliance may have a magnetron.

The microwave appliance may be a microwave cooking appliance. The microwave cooking appliance may have a cooking compartment, into which microwaves can be fed, in order to heat food located therein. The microwave cooking appliance may be a self-contained microwave cooking appliance. The microwave cooking appliance may alternatively be an oven, e.g. baking oven, with microwave functionality.

The microwave appliance may also, however, be a sterilizer for cooking utensils, etc.

In a further development, the IR detector has at least one IR sensor, which is oriented toward the at least one circuit component to be sensed. This advantageously enables a particularly simple and compact construction as well as a particularly distortion-free observation of the field of view.

In a further embodiment, the IR detector is spaced apart from the at least one circuit component to be sensed. As a result, an influencing of said circuit component is kept particularly low. It is also possible to achieve a more flexible positioning of the IR detector as a result. The IR detector being spaced apart from the at least one circuit component to be sensed comprises, in particular, a space or a gap, in particular an air gap, being located therebetween. Particularly for HF circuit components, this gap provides a particularly effective HF isolation between the at least one circuit component to be sensed and the IR detector.

In one development, the at least one temperature-sensable circuit component is accommodated in a shielding housing and the IR detector is arranged outside said housing. This is particularly advantageous for HF circuits or HF circuit components, as electrical lines of the IR detector (e.g. a data and/or power supply line) are also arranged entirely outside of the housing, and consequently no interference to the measurement and/or to a data transmission due to high-frequency fields occurs. It is also possible for line bushings through the housing to be avoided here. The presence of the electrical lines within the housing, which likewise could interfere with HF circuit components, can additionally be avoided.

In another embodiment, the IR detector has at least one IR sensor and at least one IR light waveguide and IR light emitted by the at least one circuit component to be sensed passes through the IR light waveguide and falls on the at least one IR sensor. This results in the advantage that the IR detector is able to be positioned in a particularly variable manner. The IR light waveguide may in particular have one or more fiber-optic cables.

In an additional embodiment, the IR light waveguide touches at least one circuit component to be sensed by the IR detector. This enables a particularly precise temperature measurement to be achieved. As the IR light waveguide is non-metallic, but rather consists of plastic or glass for example, it also does not interfere with the circuit component, in particular the HF circuit component.

In a further embodiment, the at least one action comprises a reduction of power fed to at least one sensable circuit component. This means that the temperature of said circuit component can be reduced. In one development, as an alternative or in addition, the control facility is configured to actuate at least one other circuit component in such a manner that the power fed to the at least one sensable circuit component is reduced or is able to be reduced. The reduction of the power may be a reduction of an electrical power and/or of a microwave power. The reduction of the power may comprise the sensable circuit component only being operated at partial performance or even being fully deactivated. The reduction of the power is therefore a possible countermeasure for reducing the temperature of the sensable circuit component.

In an alternative or additional embodiment, the sensable circuit component is an HF circuit component and at least one action comprises changing at least one HF parameter. The control facility is therefore configured to change at least one HF parameter on the basis of temperature measurement data of an HF circuit component measured by the temperature detector. Particularly in microwave appliances, the power of the microwaves reflected back can be reduced in this way, whereby the temperature in an HF circuit component—e.g. an HF transistor—can be reduced. An HF parameter may for example comprise an amplitude, a frequency and/or a phase shift of microwaves irradiated into the cooking compartment. The changing of HF parameters may correspond to a change in an operating point. The changing of the HF parameters is therefore another possible countermeasure for reducing the temperature of the sensable circuit component.

In another embodiment, the occurrence of the event which can be determined by the temperature measurement data comprises an identification of a temperature-critical operation of at least one circuit component. The control facility is therefore in particular configured to change an actuation of at least one sensable circuit component on the basis of an identification of a (temperature-)critical operation of at least one circuit component. This makes it possible to prevent an overheating of the circuit component, and possible damage thereto as a result.

In another embodiment, the temperature-critical operation comprises a predefined threshold value being reached or exceeded by a temporal temperature gradient. The control facility is therefore in particular configured to establish a temperature-critical operation by a temporal temperature gradient reaching or exceeding a predefined threshold value. With the aid of the calculated temperature gradient, it is advantageously possible to approximately infer a reflective power, in particular microwave power reflected back from a cooking compartment. If the temperature gradient rises excessively rapidly, then the actuation of the household appliance can be changed such that the power reflected back is already lowered before a critical temperature at the monitored circuit component is reached. Additionally, the temporal temperature gradient may be used to identify or diagnose a component drift and/or non-permissible deviations from known operating states.

In another embodiment, the temperature-critical operation comprises a predefined threshold value being reached or exceeded by a temperature. The control facility is therefore configured to establish a temperature-critical operation by a temperature reaching or exceeding at least one predefined threshold value. It is thus possible for an overtemperature, an advance warning temperature and/or a critical limit temperature etc. at said circuit component to be established by means of the IR detector.

In one development, the temperature-critical operation is identified on the basis of a temperature progression.

The control facility can therefore be programmed such that it identified, on the basis of an instantaneous value of the temperature, a progression of the temperature and/or a temporal temperature gradient, whether the temperature-sensed component is in normal operation (without excessively great/rapid heating) or in critical operation (with excessively great/rapid heating).

In another embodiment, the household appliance is a microwave cooking appliance, which has a solid-state amplifier with an HF transistor and with a feedthrough network connected downstream of the HF transistor, the temperature detector is arranged and configured for sensing a temperature of at least the HF transistor, and the control facility is configured to trigger, on the basis of an occurrence of an event which can be determined by the temperature measurement data, at least one action which leads to a reduction of a temperature at the HF transistor or which triggers a countermeasure for lowering the temperature at the HF temperature. The occurrence of the event may—as already described above—comprise, for example, an operation of the HF transistor in a critical temperature range or an expected entry of the HF transistor into the critical temperature range. This embodiment has the advantage that it is thus possible to respond to a temperature increase of the HF transistor which is critical, or is becoming critical, in a particularly rapid and reliable manner.

In particular, monitoring the HF transistor by means of an IR detector makes it possible to dispense with a circulator which was previously provided for protecting the HF transistor. Additionally or alternatively, it is possible to dispense with the end load. Additionally or alternatively, it is possible to dispense with a measuring facility for measuring the reflected microwave radiation. The feedthrough network may also be dispensed with, as required. All these developments result in a high cost saving due to the omission of components, compared with only low additional costs due to the provision of the IR detector. Moreover, losses due to the feedthrough network are thus also able to be reduced, which leads to a higher degree of efficiency. In other words, the microwave cooking appliance can be embodied without a circulator and/or without an end load and/or without a measuring facility for measuring the reflected microwave radiation or even entirely without a feedthrough network.

The object is also achieved by a method for operating a household appliance, having at least one circuit component, a control facility for actuating the at least one circuit component and at least one temperature detector for sensing a temperature of at least one circuit component, wherein the control facility is coupled to the at least one temperature detector and wherein in the method a temperature of at least one circuit component is sensed by means of at least one IR detector as the at least one temperature detector and the control facility actuates that household appliance on the basis of the sensed temperature. The method may be embodied in an analogous manner to the household appliance and has the same advantages.

The above-described properties, features and advantages of this invention and the manner in which these are achieved, will become clearer and more readily understandable in connection with the following schematic description of an exemplary embodiment, which will be described in further detail making reference to the drawings.

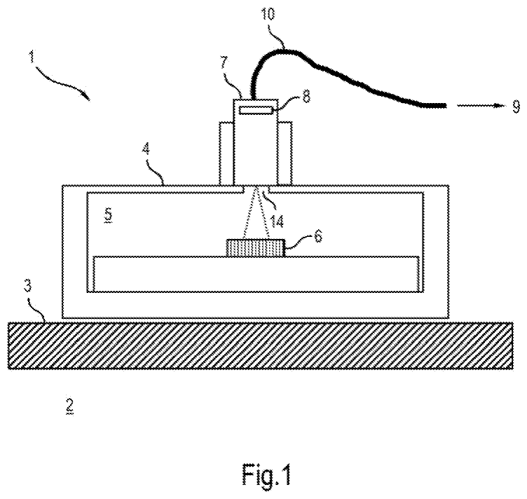

FIG. 1 shows, as a sectional representation in side view, a cutout of an outline of a microwave cooking appliance according to the invention in accordance with a first exemplary embodiment, and;

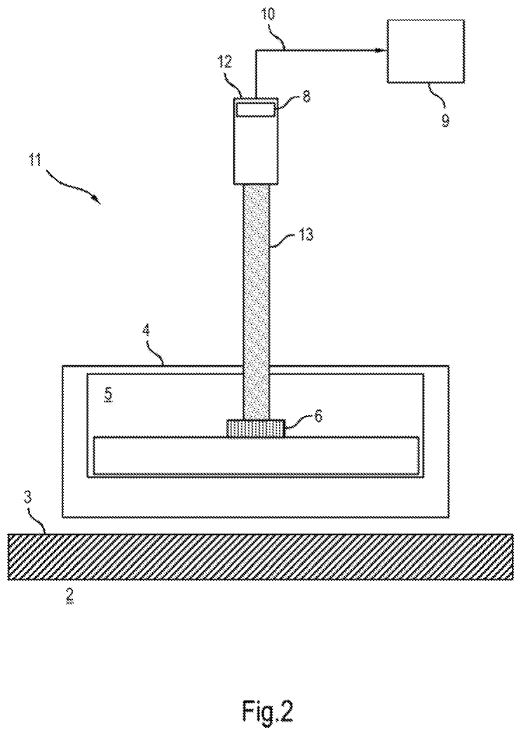

FIG. 2 shows, as a sectional representation in side view, a cutout of an outline of a microwave cooking appliance according to the invention in accordance with a second exemplary embodiment.

FIG. 1 shows a cutout of a household appliance in the form of a microwave cooking appliance 1. The microwave cooking appliance 1 has a cooking compartment 2, which is enclosed by a cooking compartment wall 3. Arranged outside the cooking compartment wall 3—here, above a ceiling of the cooking compartment wall 3—is a housing 4, which encloses an HF region 5 in a shielding manner. Accommodated in the HF region 5 is a circuit component in the form of an HF transistor 6, which comprises a part of an amplifier circuit for introducing microwaves into the cooking compartment 2.

An IR detector 7 is arranged on an outer side of the housing 4. The IR detector 7 is directed, through a window 14 in the housing 4, directly onto the HF transistor 6 and is able to sense or measure the temperature of the HF transistor 6. The IR detector 7 is thus spaced apart from the HF transistor 6. The IR detector 7 may have at least one IR sensor 8.

The IR detector 7 is coupled to a control facility 9, by means of which it is possible to actuate the amplifier circuit, possibly also the HF transistor 6, directly. The coupling may take place via a data cable 10. By way of the data cable 10, for example, temperature measurement data is transferred from the IR detector 7 to the control facility 9. The control facility 9 is configured to actuate the microwave cooking appliance 1 on the basis of the temperature measurement data measured by the IR detector 7. Specifically, the control facility 9 is configured to trigger at least one action on the basis of an occurrence of an event which can be determined by the temperature measurement data.

The at least one action may comprise a reduction of a power fed to the HF transistor 6. The power may be understood in particular to mean the microwave power reflected back from the cooking compartment 2. As an alternative, or additionally, the at least one action may comprise a change in at least one microwave parameter (such as an amplitude, a frequency and/or a phase shift of the microwaves irradiated into the cooking compartment 2), which influences the power reflected back.

The occurring event may comprise an identification of a temperature-critical operation of at least one circuit component. The temperature-critical operation may, for example, comprise a predefined threshold value being reached or exceeded by a temporal temperature gradient and/or a predefined threshold value being reached or exceeded by an (instantaneous) temperature.

In particular, the control facility 9 is configured to trigger, on the basis of an occurrence of an event which can be determined by the temperature measurement data sensed by the HF transistor 6, at least one action which leads to a reduction of the temperature at the HF transistor 6. The microwave cooking appliance 1 is thus able to rapidly respond to an impending or occurring overheating of the HF transistor 6 and implement corresponding countermeasures. This means that the amplifier circuit of the microwave cooking appliance 1 is optionally able to dispense with a circulator, an end load, a measuring facility for measuring the reflected microwave radiation or even with a feedthrough network altogether.

FIG. 2 shows, as a sectional representation in side view, a cutout of an outline of a microwave cooking appliance 11 according to the invention in accordance with a second exemplary embodiment. The microwave cooking appliance 11 is embodied similarly to the microwave cooking appliance 1, yet only one IR detector 12 has at least one IR sensor 8 and at least one IR light waveguide 13. The IR light waveguide 13 protrudes through the window 14 into the HF region 5.

The end face of the IR light waveguide 13 which couples in IR light touches the HF transistor 6 (or at least has just a very small gap in relation thereto). For this reason, IR light emitted by the HF transistor 6 is conducted through the IR light waveguide 13 to the at least one IR sensor 8. This exemplary embodiment has the advantage of only very low measurement interference due to other heat sources.

Although the IR light waveguide 13 is indicated as a straight line here, in principle it may also run at a curve. The IR sensor 8 then does not need to be oriented toward the HF sensor 6, but it may be. This enables a particularly varied positioning of the IR sensor 8.

Naturally, the present invention is not restricted to the exemplary embodiment disclosed.

In general, “a”, “an”, etc. can be understood as singular or plural, in particular in the sense of “at least one” or “one or more”, etc., provided this is not explicitly excluded, e.g. by the expression “exactly one”, etc.

A numerical value can also include the given value as a typical tolerance range, provided this is not explicitly excluded.

### LIST OF REFERENCE CHARACTERS

1 Microwave cooking appliance
2 Cooking compartment
3 Cooking compartment wall
4 Housing
5 HF region
6 HF transistor
7 IR detector
8 IR sensor
9 Control facility
10 Data cable
11 Microwave cooking appliance
12 IR detector
13 IR light waveguide
14 Window

1-16. (canceled)

17. A household appliance, comprising:
a circuit component;
a temperature detector embodied as an IR detector and configured to sense a temperature of the circuit component; and
a control facility coupled to the temperature detector and configured to actuate the circuit component and to actuate the household appliance on the basis of temperature measurement data measured by the temperature detector.

18. The household appliance of claim 17, wherein the control facility is configured to trigger an action in response to an occurrence of an event as determined by the temperature measurement data.

19. The household appliance of claim 17, wherein the circuit component is an HF component which is detectable by the IR detector.

20. The household appliance of claim 19, constructed in the form of a microwave appliance, said HF component being embodied as a microwave component.

21. The household appliance of claim 17, wherein the IR detector includes an IR sensor, which is oriented toward the circuit component.

22. The household appliance of claim 17, wherein the IR detector is spaced apart from the circuit component.

23. The household appliance of claim 17, wherein the IR detector includes an IR sensor and an IR light waveguide, said circuit component emitting IR light which passes through the IR light waveguide and falls on the IR sensor.

24. The household appliance of claim 23, wherein the IR light waveguide touches the circuit component, with the IR sensor sensing the circuit component.

25. The household appliance of claim 18, wherein the action comprises a reduction of a power fed to the circuit component.

26. The household appliance of claim 18, wherein the action comprises a change in at least one HF parameter.

27. The household appliance of claim 18, wherein the control facility is configured to identify as the occurrence of the event a temperature-critical operation of the circuit component so as to trigger the action.

28. The household appliance of claim 27, wherein the temperature-critical operation comprises a predefined threshold value being reached or exceeded by a temporal temperature gradient.

29. The household appliance of claim 27, wherein the temperature-critical operation comprises a predefined threshold value being reached or exceeded by a temperature.

30. The household appliance of claim 17, constructed in the form of a microwave cooking appliance, which comprises a solid-state amplifier with an HF transistor which forms the circuit component, said control facility being configured to trigger in response to an occurrence of an event as determined by the measured temperature measurement data an action which leads to a reduction of a temperature at the HF transistor.

31. The household appliance of claim 30, constructed such as to be without a circulator, without an end load, without a measuring facility for measuring a reflected microwave radiation and/or without a feedthrough network.

32. A method for operating a household appliance, comprising:
sensing a temperature of a circuit component of the household appliance by an IR detector; and
actuating by a control facility the household appliance in response to the temperature as sensed by the IR detector and transferred by the IR detector to the control facility.
